(19) United States
(12) Patent Application Publication
(10) Pub. No.: US 2003/0218621 A1
(43) Pub. Date: Nov. 27, 2003

(54) Method and system for edge-adaptive interpolation for interlace-to-progressive conversion

(76) Inventor: Jiande Jiang, San Jose, CA (US)

Correspondence Address: GRAY CARY WARE & FREIDENRICH LLP, 2000 UNIVERSITY AVENUE, E. PALO ALTO, CA, 94303-2248, US

(21) Appl. No.: 10/154,628

(22) Filed: May 24, 2002

(51) Int. Cl. G09G 5/02

(52) U.S. Cl. 345/698

(57) ABSTRACT

A method for edge adaptive interpolation can comprise determining if an edge extends through a pixel. If so, the group of directions and then the specific direction corresponding to the edge can be determined. The method can also include determining a value of a parameter (e.g., intensity) for the pixel. Typically, these acts may reduce the likelihood of jagged lines in the image. Optionally, post-processing can be performed to reduce the likelihood of dot defects in the image. A system may include a computer readable medium with code that comprises instructions for carrying out the method.

### TECHNICAL FIELD OF THE INVENTION

This invention relates generally to the field of processing of images and, more particularly, to methods and computer readable media used to improve the resolution of pixilated images.

### BACKGROUND OF THE INVENTION

Conventional display monitors typically present video images in the form of a rapid sequence of video fields, changed at a high frequency to create the illusion of motion. Television cameras and other sources of video generally do not produce full-frame images, but instead such video sources typically produce a field consisting of about half of the lines of each full-frame image, at a rate of, for example, 60 such fields per second (in an interlaced system). Alternate fields contain alternate lines of video data. In other words, one field contains the odd numbered lines and the next field contains the even numbered lines. Accordingly, each field of the video may be identified as an “odd” field or an “even” field.

In a typical interlaced system, the sequence of video fields thus alternates between the odd fields and the even fields. A conventional display monitor receiving the sequence of fields reproduces each video field in the sequence. Each field is displayed on the display screen, such as a television screen, on only half of the scan lines. For example, first an odd field is displayed, using the odd-numbered scan lines, and then an even field is displayed using the even-numbered scan lines, and so on. The display scans a raster across the screen from the top left to the top right producing a first scan line, and then returns the raster to the left edge of the screen to a position slightly below the original position. The position to which the raster returns, however, is not immediately below the first scan line, but allows sufficient space to accommodate an intervening scan line on the alternate field. The raster then scans across to the right edge of the screen to produce a second scan line, and continues in this manner to the bottom edge of the screen.

The distance between the scan lines is a function of the size of the monitor, but generally allows an intervening scan line (the first scan line of the other field) to be drawn after the completion of the first field. The invisible return of the raster to the left edge of the screen after scanning each scan line is a fly-back or horizontal refresh stage that occurs much more rapidly than the visible left-to-right lines. In this manner, approximately 485 active scan lines may be produced (e.g., in the predominate United States video format) to complete a single video frame, half of which is displayed in each field.

Once reaching the bottom edge of the screen, the raster is invisibly returned to the original position at the top left corner during a “vertical blanking interval” stage. The horizontal and vertical blanking interval stages are high speed and invisible. With respect to a conventional television, this interlaced video scanning approach is an appropriate compromise between vertical refresh rate, vertical resolution, and limited bandwidth.

The interlaced methods for alternating between an odd frame and an even frame used by conventional television systems, however, are well known to have various disadvantages, such as line flicker, line crawl, dot crawl, limited horizontal resolution, flashing false color, and large area flicker. Moreover, as the demand for large-screen displays increases, these problems become even more readily apparent and, hence, more critical to overcome. Various technologies have been developed, such as 3D comb filtering and interlace-to-progressive conversion, to overcome these drawbacks of conventional television signals.

Interlace-to-progressive conversion (also known as interlace-to-non-interlace conversion) involves generating a missing line between two adjacent lines in an interlaced signal. Motion adaptive interlace-to-progressive conversion is widely used in currently available interlace-to-progressive converters (“IPC”). In such an IPC, each pixel is classified as a motion pixel or a static pixel. For each static pixel, field insertion is executed to generate a corresponding missing pixel since there is no motion between consecutive fields. The same vertical resolution will be kept for the static portion of the picture. For each motion pixel, intrafield interpolation is executed to generate a corresponding missing pixel.

Most IPCs typically use only vertical interpolation for the intrafield interpolation. Hence, there will be no motion effect for the motion portion of a picture frame. However, jagged edges may result for image objects having diagonal edges. Jagged edges resulting from interpolation are a visually annoying display defect, and can sometimes occur to a degree worse than that on an interlaced display. Processing a display signal using edge-adaptive interpolation can eliminate or reduce the jagged edge defects that can result from the motion adaptive interlace-to-progressive conversion of prior art systems. However, existing edge-adaptive interpolation methods are also prone to image defects due to inaccurate image edge detection.

Aliasing (jagged edges) and reduced vertical resolution are disadvantages of interlaced scanning that interlace-to-progressive conversion attempts to correct. By the very nature of interlaced scanning, the brain is only presented with half the image scan lines at a time, although the images are registered in the human visual system (“HVS”) in very rapid succession (e.g., 50 or 60 fields (half resolution images) per second). However, this image rate will not guarantee the integration of the two fields into a full resolution frame in all cases. One effect of interlaced scanning is that the lower resolution structure of each field may become obvious under certain conditions. These conditions depend upon image content, type and magnitude of motion of the image, viewing distance, view angle, image brightness, environmental light levels and the display characteristics, such as size and calibration.

The way in which an observer views the image also affects the image integration of the two fields of each frame. To some extent, the image integration in the HVS depends on the observer keeping a fairly constant field of view. Therefore, the more the observer blinks and moves his or her eyes to pick up various parts of the image, the more likely the integration of each pair of fields will deteriorate, overall vertical resolution perception will be reduced, and other image artifacts will become more obvious.

Further, when motion occurs, particularly when it occurs between two fields of an originally interlaced video sequence, the integration of the two fields per frame diminishes as the correlation between images decreases. This can lead to an increase in the visibility of scan-like structure, saw-tooth type artifacts along edges of objects in motion, and a significant reduction of the perceived vertical resolution of areas of the image in motion. Currently existing edge-adaptive interpolation and interlace-to-progressive methods and systems only partially correct these image problems.

FIG. 1A shows a half resolution interlaced video field with aliasing (jaggies) as highlighted by the arrows. FIG. 1B shows the same image field in a full resolution progressive video frame. Although resolution is greatly increased, aliasing and other image artifacts can still occur using prior art image processing methods and systems.

### SUMMARY OF THE INVENTION

A method for edge adaptive interpolation can be used to determine more accurately an edge direction through a pixel. After an edge direction is determined. The method can also include determining a first value of a parameter (e.g., intensity) for the pixel. Typically, these acts should reduce the likelihood of jagged lines in the image. Optionally, post-processing can be performed and may reduce the likelihood of dot defects in the image. A system may include a computer readable medium with code that comprises instructions for carrying out the method.

In one set of embodiments, a method of improving the resolution of a pixilated image can comprise receiving data for a first group of pixels and a second group of pixels. The method can also comprise determining whether an edge within the image passes though a first pixel located between the first and second groups of pixels. The method can further comprise determining whether the edge extends in a first set of directions or a second set of directions to identify a selected set of directions. The method can still further comprise determining that a specific direction within the selected set of directions is closer to an actual direction. The method can yet further comprise determining a first value of a parameter for the first pixel in response to determining the specific direction.

In another set of embodiments, a computer readable medium may include code comprising instructions for carrying out the method. The computer readable medium can be in the form of a hard disk, a floppy disk, random access memory, read-only memory, or the like.

The foregoing general description and the following detailed description are exemplary and explanatory only and are not restrictive of the invention, as defined in the appended claims.

### BRIEF DESCRIPTION OF THE DRAWINGS

A more complete understanding of the present invention and the advantages thereof may be acquired by referring to the following description, taken in conjunction with the accompanying drawings in which like reference numbers indicate like features and wherein:

FIG. 1A illustrates a half resolution interlaced video field with aliasing;

FIG. 1B illustrates the same image field as FIG. 1A in a full resolution progressive video frame;

FIG. 2 illustrates a 7×2 pixel window 10 that can be used in some embodiments to detect an edge direction for generating an interpolated pixel 12;

FIG. 3 illustrates a logic block diagram of an embodiment of the overall edge adaptive interpolation method and system;

FIG. 4 is a more detailed logical block diagram of an embodiment of the edge detection algorithm;

FIG. 5 is a more detailed representation of edge detection block 14 of FIGS. 3 and 4;

FIG. 6 illustrates a more detailed logical block diagram of direction detection block 20 of FIG. 3;

FIG. 7 illustrates a more detailed logical block diagram of direction detection block 18 of FIG. 3;

FIG. 8 illustrates the logic of encoder 22 of FIG. 3; FIG. 9 is a simplified logic block diagram illustrating the logic within interpolation block 24 of FIG. 3;

FIG. 10 is a diagram showing the pixels used in an embodiment of a post-processing method;

FIG. 11 is a more detailed block diagram showing the logic of post-processing block 26 of FIG. 3;

FIG. 12A is a partial screen shot of an image showing the result of an interlace-to-progressive conversion using only vertical interpolation;

FIG. 12B is a partial screen shot of the same image as in FIG. 12A after interlace-to-progressive conversion using an embodiment of the edge adaptive interpolation and edge detection algorithms, but without post-processing; and

FIG. 12C illustrates a partial screen shot of the same image as in FIGS. 12A and 12B after interlace-to-progressive conversion using an embodiment of the proposed method and system including post-processing.

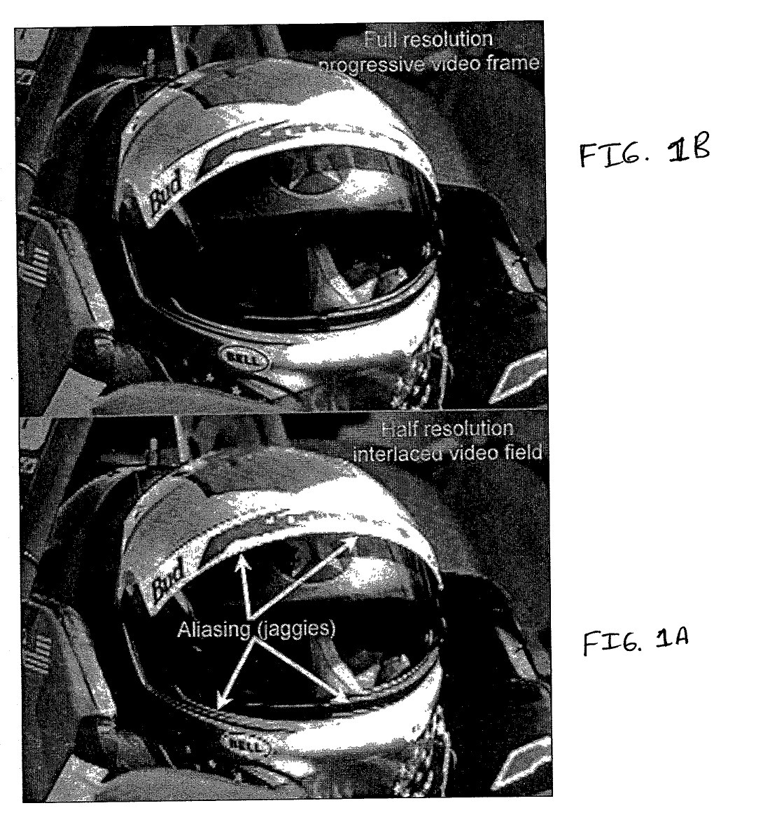

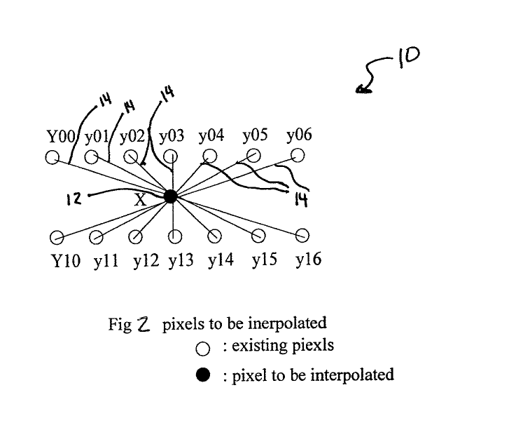

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Preferred embodiments of the present invention are illustrated in the FIGUREs, like numerals being used to refer to like and corresponding parts of various drawings.

A method for edge adaptive interpolation can comprise determining if an edge extends through a pixel. If so, the group of directions and then the specific direction corresponding to the edge can be determined. The method can also include determining a first value of a parameter (e.g., intensity) for the pixel. Typically, these acts may reduce the likelihood of jagged lines in the image. Optionally, post-processing can be performed and reduce the likelihood of dot defects in the image. A second value of the parameter for the pixel may be determined. If post-processing is performed, the pixel can be assigned the second value of the parameter. Otherwise, the first value may be used. A system may include a computer readable medium with code that comprises instructions for carrying out the method.

Before addressing details of embodiments described below, some terms are defined or clarified. As used herein, the term “closer” and other comparative terms are to be construed as “closest” when three or more items are being compared.

The terms “actual image,” “actual edge,” and “actual direction” correspond to physical objects or a different image to which the pixilated image corresponds. The actual image, actual edge, and actual direction are parts of the input that will be output as a pixilated image. Ideally, the pixilated image will be substantially identical to the actual image.

As used herein, the terms “comprises,” “comprising,” “includes,” “including,” “has,” “having” or any other variation thereof, are intended to cover a non-exclusive inclusion. For example, a process, process, article, or apparatus that comprises a list of elements is not necessarily limited only those elements but may include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

To perform edge adaptive interpolation along an image object's edge, the direction of an edge passing through a missing pixel can be correctly determined (a pixel that will be generated to form the interpolated line between existing adjacent lines in the interlace signal being converted). Various window sizes can be used to detect the possible edge direction. For example, FIG. 2 shows a 7×2 pixel (seven pixel pairs from the two interlaced signal lines on either side of a line to be interpolated, one pixel in each pixel pair belonging to each interlaced line) window 10 that can be used to detect an edge direction for generating an interpolated pixel 12. For a 7×2 pixel window 10, there are seven possible edge directions, as indicated by edge direction lines 14. The two rows of seven pixels will be the data that is received by a processor or system before proceeding with the rest of the method.

As shown in FIG. 2, the upper interlaced line of 7×2 pixel window 10 comprises pixels Y00 through Y06, and the lower line comprises pixels Y10 through Y16. In comparison, a 3×2 pixel window has only three possible directions along which an edge may lie. It is easy to see, therefore, that the computational resources required to detect an edge direction using a 7×2 pixel window 10 are greater than what is needed for a 3×2 pixel window. The larger the window size, the greater the computational resources required. Further, the larger the window, the more likely that a false edge direction detection can occur.

If a false edge direction occurs, the result can be dot defects on the interpolated image. Some prior art edge-adaptive interpolation methods and systems employ 3×2 pixel windows to minimize the computational resources required and also the possibility of false edge direction detection. However, with a 3×2 pixel window, the interpolation can only occur along the 45°, 90° and 135° directions. The result is that there will be aliasing (jaggies) on most of the edge along an image object.

Many embodiments can use at least five pixels in row (group) of pixels within a window (e.g., 5×2 pixel window). Although there is not theoretical maximum number of pixels in a row, to many pixels may increase computation time to an unacceptable level. A 7×2 pixel window 10 can be used to detect edge direction and can further employ post-processing to remove any resulting artifacts due to, for example, false edge direction detection. The rows extend in directions substantially parallel to each other.

The embodiments can use a hierarchal scheme to reduce the computational resources required to process a video signal. The embodiments can first detect if there is an edge existing along a pixel of interest. If there is no edge detected, or if the detected edge is along the vertical direction, then the edge direction detection output will be 90° (the interpolation will be done along the vertical direction). If there is an edge, a next act can be to detect whether the edge direction is along the 0° to 90° range or along the 90° to 180° range. Once the edge direction range has been determined, the edge direction can then be more precisely detected from among the three possible directions in each range (i.e., for the 0° to 90°0 range and the 90° to 180° range). It is possible to detect a false edge direction, and thus a defect can result along the interpolation following the detected edge direction. Embodiments can further comprise a post-processing block to remove these defects, thus generating a more reliable defect-free image.

Returning now to FIG. 2, FIG. 2 shows a 7×2 pixel window 10 that can be used to detect edge direction along interpolated pixel 12. Pixels Y00 to Y06 are pixels in the interlaced line directly above a line to be interpolated and pixels Y10 to Y16 are pixels in the line directly below the line to be interpolated. With reference to FIG. 2, an embodiment of the edge-adaptive interpolation method can comprise the following: If a detected edge is along the edge direction line 14 intersecting pixels Y00 and Y16 (corresponding to an edge direction of 161.50), then the luminance value for interpolated pixel 12 is set equal to (Y00+Y16) divided by 2. If a detected edge is along the edge direction line 14 connecting pixels Y01 and Y15 (corresponding to an edge direction of 153.50), then the luminance value of interpolated pixel 12 is set equal to (Y01+Y15) divided by 2. If a detected edge is along the edge direction line 14 connecting pixels Y02 and Y14 (corresponding to an edge direction of 135°), then the luminance value of interpolated pixel 12 is set equal to (Y02+Y14) divided by 2. If a detected edge is along the edge direction line 14 connecting pixels Y04 and Y12 (corresponding to an edge direction of 45°), then the luminance value of interpolated pixel 12 is set equal to (Y04+Y12) divided by 2. If the detected edge along the edge direction line 14 connecting pixels Y05 and Y11 (corresponding to an edge direction of 26.50), then the luminance value of interpolated pixel 12 is set equal to (Y05+Y11) divided by 2. If the detected edge is along the edge direction line 14 connecting pixels Y06 and Y10 (corresponding to an edge direction of 18.50), then the luminance value of interpolated pixel 12 is set equal to (Y06+Y10) divided by 2. Otherwise, interpolated pixel 12 is set equal to (Y03+Y13) divided by 2, which corresponds to either a detected edge direction along the 90° line 14 or to no edge. For purposes of this description, reference to a pixel (e.g., Y00−Y16) identifies the pixel and refers to its luminance value.

The discussion above presupposes that an edge is detected along one of the edge direction lines 14. However, a difficult act in edge-adaptive interpolation is detecting the edge direction. A method for detecting the edge direction can comprise an edge direction detection algorithm as described more fully below. Further, many embodiments can be implemented within edge-adaptive IPCs and also within motion and edge-adaptive IPCs, such as those disclosed in related U.S. Patent Application entitled “Method and System for Single-Chip Integration of 3D Y/C Comb Filter and Interlace-to-Progressive Converter” filed Oct. 20, 2001 (the “Single-Chip Integration” application), which assigned to the current assignee hereof. Many embodiments described herein can be implemented within HDTV (High Definition Television) display monitors, HDTV-ready display monitors, and progressive scan display monitors.

As mentioned above, many embodiments can use a hierarchal scheme to simplify the computations required for edge direction detection. In its simplest form, there are three acts to identify the direction of an edge through an interpolated pixel 12. First, the embodiments can determine if an edge exists through interpolated pixel 12. Second, if an edge exists through interpolated pixel 12, the seven possible edge directions in a 7×2 pixel window 10 are classified into three groups and the detected edge is assigned to one of these groups. The first group comprises directions of 18.5°, 26.5° and 45° (the range from 0° to 90°). The second group comprises a direction of 90°, which means either that no edge exists or that an edge exists along the 90° direction. The third and final group comprises directions of 135°, 153.5° and 161.5° (the range from 90° to 180°). Other than the 90° direction, note that the number of directions within each group of directions is an integer equal or closest to:

(Nₚᵣ−1)/2

where Nₚᵣ is the number of pixels within each row of the window.

The second act comprises identifying the group to which the detected edge belongs. Third, once the edge direction is assigned to a direction group, if the edge direction is within groups one or three, then the embodiments can be used to further determine the edge direction from among the three possible directions within each of groups one and three.

Although in FIG. 2 only a 7×2 pixel window 10 is shown, an image containing pixel window 10 can comprise multiple pixels and multiple lines, as is well known to those in the art. The edge detection and edge adaptive interpolation method can be performed for each pixel of an interpolated line. Therefore, fourteen pixels can be used to interpolate each new pixel in an interpolated line (although each pixel can be used to interpolate more than one pixel). This is in contrast to prior art systems and methods that use only two pixels to generate an interpolated pixel (e.g., the pixel directly above and the pixel directly below interpolated pixel 12), which is more likely to result in a jagged edge defect in the displayed image. Other pixel window sizes can be used (e.g., a 5×2 or a 9×2 window), but they are a compromise between calculation complexity and performance. A 7×2 pixel window 10 is a good compromise between complexity and performance.

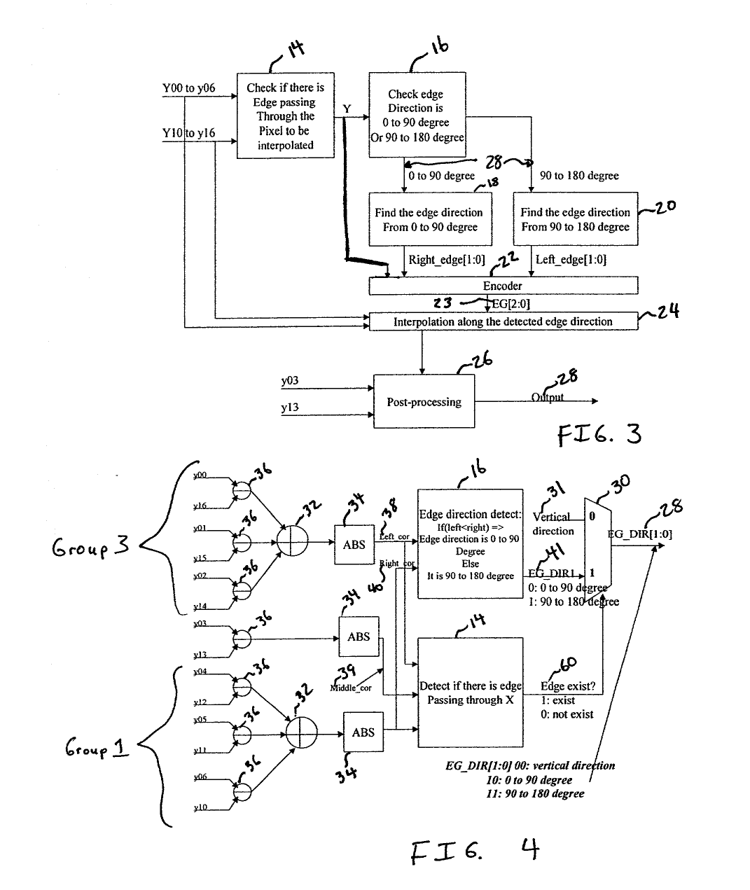

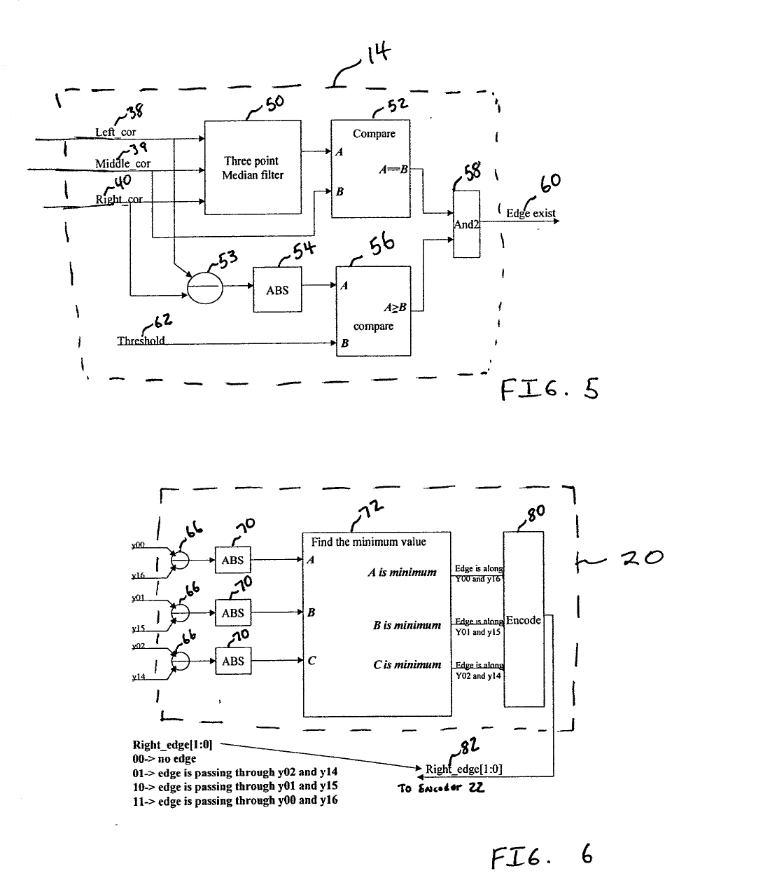

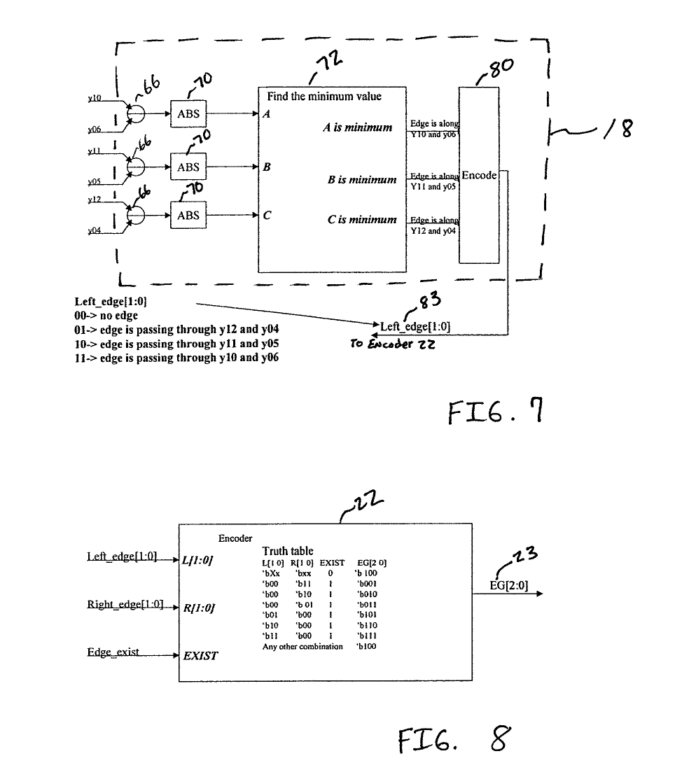

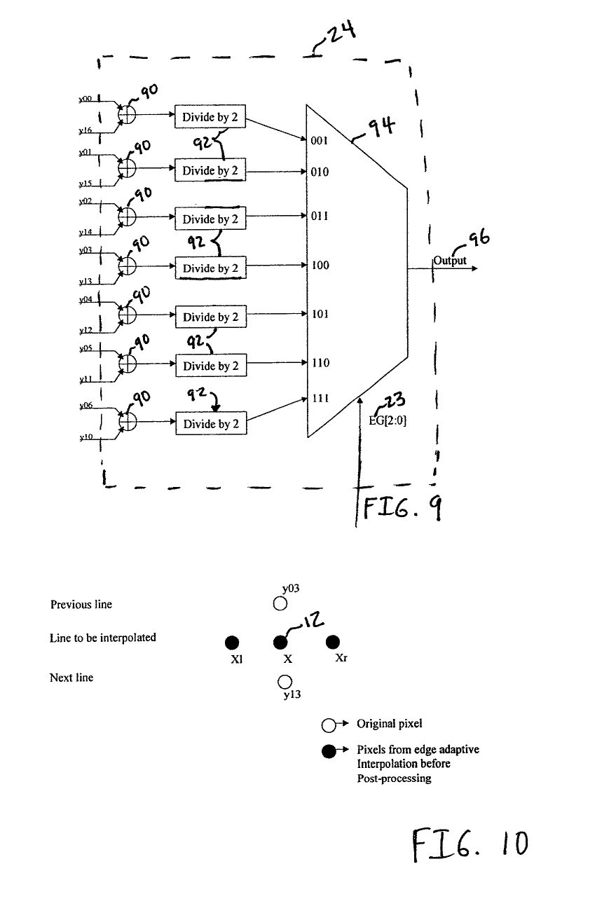

FIG. 3 is a logic block diagram of an embodiment of the overall edge adaptive interpolation method. FIGS. 4 through 7, discussed in greater detail below, describe embodiments of the edge direction detection algorithm. As shown in FIG. 3, edge detection block 14 takes as inputs the luminance values for pixels Y00 to Y06 and pixels Y10 to Y16 from FIG. 2. As discussed with reference to FIG. 2, these pixels are located in the lines immediately above and immediately below the line to be interpolated. Edge detection block 14 determines if there is an edge passing through a pixel to be interpolated (e.g., interpolated pixel 12). The logical output of edge detection block 14 is provided as an input to range detection block 16 and to encoder 22.

At range detection block 16, embodiments can be used to determine if a detected edge direction is in the 0° to 90° range group or in the 90° to 180° range group. The logical output from range detection block 16 can be a two-bit signal EG_DIR signal 28, discussed in more detail with reference to FIG. 4. EG_DIR signal 28 is provided as an input to direction detection blocks 18 and 20. Direction detection block 18 determines the detected edge direction in the range from 0° to 90° and direction detection block 20 determines the detected edge direction in the range from 90° to 180°. Edge detection block 14 provides a direct input to encoder 22 for the case of no detected edge or an edge direction of 90°. The outputs from direction detection blocks 18 and 20, along with the output from edge detection block 14, are provided as inputs to encoder 22.

Encoder 22 takes as inputs a one-bit output signal from edge detection block 14 and the two two-bit output signals from direction detection blocks 18 and 20. Encoder 22 provides as an output a three-bit selector signal EG 23 that is used as a selector input to interpolation block 24. Interpolation block 24, as will be explained in greater detail with reference to FIG. 9, comprises a multiplexer 94 that takes as inputs the average luminance value of matched pixel pairs, one pixel in each pair from pixels Y00 to Y06 and the other from pixels Y10 to Y16. Encoder 22 outputs a signal corresponding to the detected edge direction of an edge (or no edge) passing through interpolated pixel 12.

Interpolation block 24 takes as an input selector EG signal 23 to select an output from among seven other inputs, as shown in FIG. 9. The seven other inputs to interpolation block 24 each comprise an average of the luminance values for a pixel pair, wherein each pixel pair comprises two pixels that are each intersected by a same direction line 14 of FIG. 2. Further, the pixels in each pixel pair comprise one pixel each from the interlaced line immediately above and the interlaced line immediately below the line containing interpolated pixel 12. The output from interpolation block 24 is the luminance value for interpolated pixel 12, which will be generated within the displayed image. Interpolation block 24's output is provided to post-processing block 26, which also takes as an input the luminance values for the pixels (Y03 and Y13) immediately above and immediately below interpolated pixel 12. Post-processing block 26 removes defects that may have been generated as part of the interpolation process and provides a clean output signal 28 comprising a defect-free luminance value for generating interpolated pixel 12 within the image to be displayed.

FIGS. 4 through 7 provide more detailed representations of the processes described above with reference to FIG. 3. FIGS. 4 through 7 further describe an embodiment of the edge detection algorithm. Turning to FIG. 4, a right correlation, middle correlation and left correlation signal are generated from the luminance values of the seven pixels pairs discussed with reference to FIGS. 2 and 3. The difference between the luminance values of the two pixels in each pixel pair are taken, for each pixel pair, at a difference block 36. The pixel pair luminance value differences for the pixel pairs of group 3 (Y00−Y16, Y01−Y15 and Y02−Y14), are summed at a summing block 32 and the sum signal forwarded to an absolute value block 34, which takes the absolute value of the sum and outputs it as left correlation signal 38. Left correlation signal 38 is thus equal to the absolute value of [(Y00−Y16)+(Y01−Y15)+(Y02−Y14)].

In a similar manner, the luminance values for the pixel pairs from group 1 (Y04−Y12, Y05−Y11, and Y06−Y10) are used to generate right correlation signal 40. The value of right correlation signal 40 is thus equal to the absolute value of [(Y06−Y10)+(Y05−Y11)+(Y04−Y12)]. Middle correlation signal 39 is generated in a similar fashion by taking the absolute value (at an absolute value block 34) of the difference between the luminance values of the pixels in the pixel pair comprising pixels Y03 and Y13 (the pixels immediately above and immediately below interpolated pixel 12). Middle correlation signal 39 is thus equal to the absolute value of (Y03−Y13). In each of these correlation values, Y00 through Y06 and Y10 through Y16 represent the luminance value of the corresponding pixel as depicted in FIG. 2.

It should be noted that the luminance values of the image pixels are used by the embodiments because the human eye is very sensitive to luminance differences. The chroma value (color) of the pixels is not used in the interpolation along an edge because the human eye is relatively insensitive to color differences as compared to luminance differences. Still, the chroma value or other parameter may be used with the method described herein instead of or in conjunction with the edge detection. Further, as shown in FIG. 2, the edge direction is ultimately determined by the method to lie along one of the edge direction lines 14, which intersect interpolated pixel 12 and a pair of pixels, one each from the line immediately above and from the line immediately below interpolated pixel 12. Many embodiments can average the luminance values of the pixel pair pixels intersected by the detected edge direction line 14 to generate the luminance value of interpolated pixel 12.

The existence of an edge through an interpolated pixel 12 is determined at edge detection block 14. Edge detection block 14 of FIG. 4 is the same edge detection block 14 of FIG. 3. Further, FIG. 5 is a more detailed representation of edge detection block 14 of FIGS. 3 and 4. Turning now to FIG. 5, the logic of edge detection block 14 is shown. Edge detection block 14 takes as inputs left correlation signal 38, middle correlation signal 39, right correlation signal 40 and a threshold signal 62. Left correlation signal 38, middle correlation signal 39 and right correlation signal 40 are provided as inputs to three-point median filter 50, which provides as an output the median value of the three input signals. For example, if the three input signals into three-point median filter 50 have values of 1, 7 and 10, the output would be the input signal having a value of 7. The output from three-point median filter 50 is provided as an input to the “A” input of comparator 52. Comparator 52 also takes as an input middle correlation signal 39 (at input “B”) and compares it to the output from three-point median filter 50. If the two signals are equal, comparator 52 provides as an output a logical 1. If the two input signals to comparator 52 are not equal, comparator 52 provides a logical 0 as an output. The output from comparator 52 is provided as an input to AND gate 58.

Left correlation signal 38 and right correlation signal 39 are also provided as inputs to a difference block 53, which takes the difference of the two signals and provides it as an input to absolute value block 54. Absolute value block 54 generates the absolute value of the input signal value. The output from absolute value block 54 is provided as to an input A of comparator block 56. Comparator block 56 also receives at an input B a threshold value 62. Comparator block 56 compares inputs A and B to one another and if the signal to input A is greater than or equal to the signal to input B, the output from comparator block 56 is a logical 1. If input A is less than the threshold 62 (input B), then the output from comparator block 56 is a logical 0. The output from comparator block 56 is provided as a second input to AND gate 58.

AND gate 58 thus takes as inputs the outputs from comparators 52 and 56 and provides as an output an edge-exist signal 60. Edge-exist signal 60 will be a logical 1 if both of the inputs to AND gate 58 are logical 1's. This corresponds to a condition where (i) middle correlation signal 39 is the median of the left correlation signal 38, middle correlation signal 39 and right correlation signal 40 and (ii) the absolute value of the difference between left correlation signal 38 and right correlation signal 40 is greater than or equal to a threshold signal 62. Threshold signal 62 can have an arbitrarily determined value, with a typical value of around 32. The threshold signal 62 value can be set for a given application and typically does not change for that application.

Returning now to FIG. 4, edge-exist signal 60 from FIG. 5 is provided as an input to multiplexer 30. Edge-exist signal 60 is a selector signal used by multiplexer 30 to select which of the two other inputs to multiplexer 30 (vertical direction signal 31 or EG_DIR signal 41) will be output from multiplexer 30.

A first act of an embodiment of the edge detection algorithm can thus comprise determining if an edge exists through interpolated pixel 12 by determining if middle correlation signal 39 is the median of left correlation signal 38, middle correlation signal 39 and right correlation signal 40, and further determining if the absolute value of the difference between left correlation signal 38 and right correlation signal 40 is greater than or equal to a threshold signal 62. If both of these conditions are true, then an edge is determined to exist; otherwise, an edge does not exist or the edge lies along the 90° direction (which condition is treated the same as if the edge does not exist).

Returning now to FIG. 4, a next act is to determine to which direction group a detected edge belongs. This is accomplished at range detection block 16, which takes as inputs left correlation signal 38 and right correlation signal 40. Range detection block 16 compares left correlation signal 38 to right correlation signal 40. If the value of left correlation signal 38 is less than the value of right correlation signal 40, then the edge direction belongs to group 3, corresponding to the 90° to 180° direction range. Otherwise, the edge direction is within group 1, comprising the 0° to 90° direction range. The EG_DIR1 output signal 41 from range detection block 16 is a logical 0 if the edge direction is within group 1 or a logical 1 if the edge direction is within group 3.

EG_DIR 1 signal 41 is provided as input “1” to two-way multiplexer 30. Vertical direction input signal 31 is provided as a second input (input “0”) to multiplexer 30. Vertical direction input signal 31 represents an edge detected along the vertical direction (90°). Thus, once the method determines that an edge does or does not exist and, if the edge does exist, the direction group to which the edge belongs, multiplexer 30 takes as an input edge-exist signal 60, EG_DIR1 signal 41 and vertical direction signal 31 and provides as an output EG_DIR signal 28. EG_DIR signal 28 is a two-bit signal that indicates the group to which a detected edge passing through interpolated pixel 12 belongs. If EG_DIR signal 28 comprises a logical 00, then the detected edge direction is 90°. If EG_DIR signal 28 comprises a logical 10, the detected edge direction is in the 0° to 90° group. Lastly, if EG_DIR signal 28 is a logical 11, the detected edge direction is in the 90° to 180° direction group. EG_DIR signal 28 is provided as an input to direction detection blocks 18 and 20 of FIG. 3, the logic of which are shown in greater detail in FIGS. 7 and 6 respectively.

Once the existence of an edge is determined, and the detected edge direction is assigned to a direction group, a next act of the method is to determine along which of the seven possible direction lines 14 of a 7×2 pixel window 10 the edge exists. FIGS. 6 and 7 are logical block diagrams illustrating an embodiment for determining the detected edge direction when it has been determined that the edge direction lies within the 90° to 180° range or the 0° to 90° range, respectively. This discussion will focus on FIG. 6, but the discussion with respect to FIG. 7 is substantially identical.

FIG. 6 illustrates how the method can detect an edge's direction from a group of edge directions when the edge direction is found to be in the 90° to 180° range. FIG. 6 is a more detailed logical block diagram of edge direction detection block 20 from FIG. 3. Similarly, FIG. 7 is a more detailed logical block diagram of direction detection block 18 of FIG. 3. As shown in FIG. 6, the difference in the luminance values of the pixels in each of the three pixel pairs belonging to direction Group 3, as designated in FIG. 4 (i.e., Y00−Y16, Y01−Y15, and Y02−Y14), is determined at a separate difference block 66 and each difference signal output to a separate absolute value block 70. Absolute value blocks 70 each provide as an output signal the absolute value of their respective input signal to minimum value processor 72.

Minimum value processor 72 thus takes three inputs (at input points A, B and C), each corresponding to the absolute value of the difference of the luminance values of a corresponding pixel pair. Minimum value processor 72 compares the three input signals to determine which is the minimum luminance value. Input A receives a signal corresponding to the absolute value of the difference between the luminance values of pixels Y00 and Y16. Input B receives a signal corresponding to the absolute value of the difference between the luminance values of pixels Y01 and Y15. Input C receives a signal corresponding to the absolute value of the difference between the luminance values of Y02 and Y14. Thus, if the value of signal C is less than or equal to the value of signal B and is also less than or equal to the value of signal A, then the edge direction is 135° (the detected edge direction lies through pixel pair Y02−Y14). If instead, the value of signal B is less than or equal to the value of signal A and less than or equal to the value of signal C, then the edge direction is 153.5° (the detected edge direction lies through pixel pair Y01−Y15). Otherwise, the edge direction is 161.5° (the detected edge direction lies through pixel pair Y00−Y16).

If signal A is the minimum value, then the output from minimum video processor 72 is a three-bit logical signal 100, where a logical 1 is assigned to a minimum value and a logical 0 is assigned to a non-minimum value. Similarly, if signal B is the minimum, then the output from minimum value processor 72 will be a logical 010. Likewise, if the signal input to point C is the minimum, the output from minimum value processor 72 will be a logical 001. Note, however, that more than one of signals A, B, and C can be a minimum, and, in fact, if all 3 are equal, they are all minimums and the output from minimum value processor 72 is a logical 111. The three one-bit output signals from minimum value processor 72 are input to encoder 80, which further takes as an input the two-bit EG_DIR signal 28 of FIG. 4.

Encoder 80 thus takes as inputs five bits and provides as an output a two-bit right_edge signal 82. Right_edge signal 82, and the corresponding left_edge signal 83 from the logic depicted in FIG. 7 for the 0° to 90° edge direction range, are provided as inputs to encoder 22 of FIG. 3, as previously discussed. Right edge signal 82 can comprise a logical value of 00, indicating no edge exists, a value of 01, indicating a detected edge direction of 135°, a value of 10, corresponding to a detected edge direction of 153.5°, or a value of 11, corresponding to a detected edge direction of 161.5°. If there is more than one minimum, the direction closer to 90° may be chosen. The values for right edge signal 82 are encoded into the logic of encoder 80 to correspond to the various possible inputs to encoder 80.

Similarly, FIG. 7 illustrates the corresponding logic for the situation where an edge is determined to pass through the 0° to 90° direction range. The logic of FIG. 7 is substantially identical to that of FIG. 6, the only difference being the different pixel pairs used. Like-numbered components in FIG. 7 correspond to like-numbered components in FIG. 6, and provide the same function for the different inputs corresponding to the luminance values of the pixels in the pixel pairs of group 1.

Returning now to FIG. 3, once the detected edge direction has been determined, right_edge signal 82 and left_edge signal 83 are provided to encoder 22. The one-bit output signal from edge detection block 14 is also input to encoder 22 to indicate whether an edge exists. Encoder 22 thus takes five bits as inputs and provides a three-bit output EG signal 23 to interpolation block 24. The logic of encoder 22 is illustrated in FIG. 8. As shown in FIGS. 8 and 9, the value of EG signal 23, one of fifteen inputs to edge adaptive interpolation block 24 of FIG. 3, is used to select one of seven input signals to multiplexer 94 of FIG. 9 that will be output to post-processing block 26 of FIG. 3 as the luminance value for interpolated pixel 12.

FIG. 9 is a simplified logic block diagram illustrating the logic within interpolation block 24 of FIG. 3. As can be seen in FIG. 9, interpolation block 24 takes as inputs the luminance values for pixels Y00 through Y06 and pixels Y10 through Y16 of FIG. 2. Seven pixel pairs (as described previously) each have their luminance values summed at separate summing blocks 90. The sum of each pixel pair luminance values is provided to a separate division circuit block 92, which divides the sum by two. The result is that the luminance values of each pixel pair are averaged and each average luminance value signal is provided as an input to multiplexer 94. In addition to the seven average luminance value signals, multiplexer 94 takes as an input EG signal 23. EG signal 23 acts as a selector signal to determine which of the seven average luminance value signals will be provided as an output signal 96 from multiplexer 94. Output signal 96 from multiplexer 94, and hence from interpolation block 24, corresponds to the luminance value for interpolated pixel 12. In other words, output signal 96 can be used to generate interpolated pixel 12 on the displayed image.

As shown in FIG. 9, generating interpolated pixel 12 comprises calculating the average luminance value of the pixels in a pixel pair that lies along the detected edge direction of an edge passing through interpolated pixel 12. The luminance value of interpolated pixel 12 will have a value equal to the average luminance of the two pixels located in the line immediately above and in the line immediately below the interpolated line containing interpolated pixel 12 and that lie along the detected edge direction determined in accordance with the teachings herein. Thus, if the detected edge direction is along the 18.5° direction line 14, interpolated pixel 12's luminance value is equal to the luminance value of pixel Y06 plus the luminance value of pixel Y10 divided by two. Thus, for detected edge directions along each edge direction line 14, the corresponding luminance value for interpolated pixel 12 is provided according to the following:

| | |
|---|---|
| If(detected edge direction=18.5°) | then X=(Y06+Y10)/2 |
| Else if(detected edge direction=26.5°) | then X=(Y05+Y11)/2 |

Else if(detected edge direction=45°) then X=(Y04+Y12)/2

| | |
|---|---|
| Else if(detected edge direction=135°) | then X=(Y02+Y14)/2 |
| Else if(detected edge direction=153.5°) | then X=(Y01+Y15)/2 |
| Else if(detected edge direction=161.5°) | then X=(Y00+Y16)/2 |

| | |
|---|---|
| Else | X=(Y03+Y13)/2 |

Where X is the luminance value of interpolated pixel 12.

It should be noted that the video signal provided as an input to a display system can be in the form of a composite video signal. A composite video signal can be an NTSC signal, a PAL signal, or any other such signal as known to those in the art. NTSC stands for National Television Standards Committee and defines a composite video signal with a refresh rate of about 60 half frames (interlaced) per second. Each frame contains 525 lines and can contain 16 million different colors. A composite video signal provided as an input can also be a signal for a high definition ready television, that can provide much better resolution than current television standards based on the NTSC standards. PAL stands for Phase Alternating Line, the dominant television standard in Europe. Whereas, NTSC delivers 525 lines of resolution at 60 half frames per second, PAL delivers 620 lines at 50 half frames per second. The PAL and NTSC specifications are well known to those in the art.

In some instances, the method for detecting an edge direction and performing edge adaptive interpolation can result, if there is any edge direction detection error, in generating a distorted output. If such a distorted output is forwarded directly to a display, image defects, such as dot noise, can occur. Edge direction detection errors can occur with any algorithm, especially for images with much detail. Therefore, to correct for such artifacts associated with errors in edge direction detection, many embodiments can provide for post-processing, after the edge adaptive interpolation, to reduce or eliminate noise.

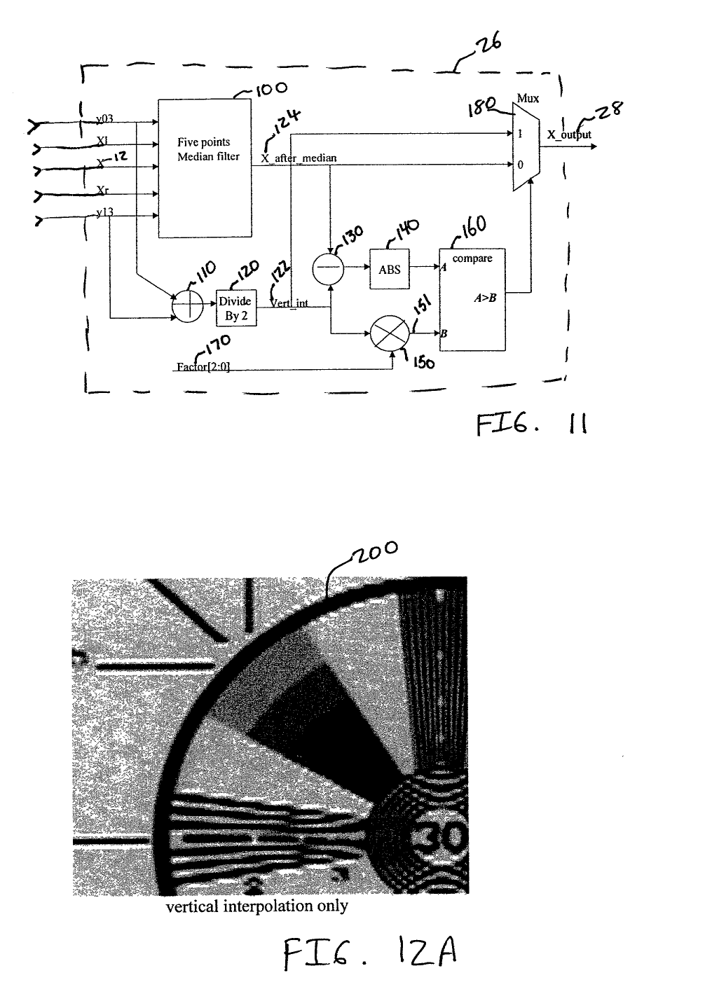

Returning now to FIG. 3, post-processing is performed at post-processing block 26, which also takes as inputs the luminance values for the pixel directly above and the pixel directly below interpolated pixel 12, the luminance values for previously interpolated pixels immediately to the left and immediately to the right of the interpolated pixel 12, and also the luminance value for the newly interpolated pixel 12 itself (output from interpolation block 24 of FIG. 3). This process is explained in greater detail with respect to FIGS. 10 and 11.

FIG. 10 is a diagram of the pixels used for post-processing in accordance with the teachings described herein. FIG. 10 includes newly interpolated pixel 12, and pixel Y03 and pixel Y13 (the pixels immediately above and immediately below interpolated pixel 12. FIG. 10 further includes interpolated pixel Xl and interpolated pixel Xr, which are previously interpolated pixels to the immediate left and to the immediate right, respectively, of interpolated pixel 12. Interpolated pixels 12, Xl and Xr are shown after edge adaptive interpolation, but before the post-processing algorithm is applied to them. FIG. 10 thus represents the inputs to post-processing block 24 and their relationship to one another.

FIG. 11 is a more detailed block diagram showing the logic of post-processing block 26 of FIG. 3. Post-processing block 26 comprises a five-points median filter 100, which takes as inputs the luminance values for pixels Y03 and Y13, as well as the luminance values for interpolated pixels 12, Xr and Xl. Because interpolated pixel 12 (“X”) is interpolated using the pixels in the line immediately above and the line immediately below the line to be interpolated, there should be no vertical high frequency component along the pixels immediately above and immediately below interpolated pixel 12 (i.e., along Y03, X, and Y13, where X is the edge adaptive interpolation result [pixel 12]). Because of this, if the luminance value of interpolated pixel 12 is greater than that of both pixels Y03 and Y13, or if the luminance value of interpolated pixel 12 is less than that of both pixels Y03 and Y13, it is assumed that the luminance value calculated for interpolated pixel 12 is incorrect, or that it includes dot noise created by an incorrect edge direction detection. It is well known in the art that a median filter can provide the ability to remove impulsive noise. The method can use five-points median filter 100 to remove the dot noise.

As shown in FIGS. 10 and 11, two acts can occur at post-processing block 26. The pixel luminance values are input to five-points median filter 100, which provides as an output X_after_median signal 124. X_after_median signal 124 is the median signal value from the five input signals to five-points median filter 100. Thus, X_after_median signal 124 is equal to the signal corresponding to the median luminance value out of pixels Y03, Y13, interpolated pixel 12, Xl, and Xr. Y03 is the luminance value of the pixel directly above interpolated pixel 12, Y13 is the luminance value for the pixel immediately below interpolated pixel 12, Xl is the luminance value for the pixel generated by edge adaptive interpolation immediately to the left of interpolated pixel 12 and Xr is the luminance value for the pixel generated by edge adaptive interpolation immediately to the right of interpolated pixel 12. Thus, an embodiment of the post-processing method can comprise taking as inputs the luminance values of three pixels previously generated for the line to be interpolated by the embodiments of the edge detection and edge adaptive interpolation methods, and using the three luminance values for post-processing clean-up references. In the case of a pixel at a boundary of the image, there is no post-processing performed and the pixel at a boundary of an image is instead sent to a display in the form it comes out of interpolation block 24.

As a second act in the post-processing, X_after_median signal 124 is compared with the average of the luminance values of pixels Y03 and Y13 to determine if the difference between X_after_median signal 12 and this average is greater than a preset value. If the difference is greater than the preset value, the interpolation result is deemed to be unreliable and the output value for the interpolated pixel 12 is replaced by the output value of the average of the pixels immediately above and immediately below the interpolated pixel 12.

Thus, as can be seen in FIG. 11, luminance values for pixels Y03 and Y13 are added at summing block 110 and the sum is provided to division block 120, where it is divided by two. The output from division block 120 is vertical_int signal 122, which is provided, along with X_after_median signal 124, to difference block 130, which takes the difference of the two signals. This difference is provided as an input to absolute value block 140, which takes the absolute value of the difference and provides it as an input (input “A”) to comparator 160. Vert_int signal 122 is also provided as an input to product block 150, which multiplies the value of vert_int signal 122 by a factor 170. Product signal 151, comprising the product of vert_int signal 122 and factor 170, is provided as a second input to comparator 160 (input “B”). Factor 170 can be an arbitrarily determined value less than one, and typically is set to about 0.75, although other values may be used.

At comparator 160, if the absolute value of the difference between X_after_median signal 124 and vert_int signal 122 is greater than the product of vert_int signal 122 and factor 170 (i.e., the A input of comparator 160 is greater than the B input), then the output from multiplexer 180 (output signal 28) is selected to be vert_int signal 122, corresponding to the average luminance value of pixels Y03 and Y13. Otherwise, output signal 28 from multiplexer 180 (i.e. the output signal from post-processing block 26) will be X_after_median signal 124. Comparator 160 compares the signal at its A input to the signal at its B input and provides a logical 1 if signal A is greater than signal B or a logical 0 if signal A is less than or equal to signal B.

Therefore, a logical 1 is output to multiplexer 180 when the absolute value of the difference between X_after_median signal 124 and vert_int signal 122 is too great (i.e., greater than the product of vert_int signal 122 and factor 170), which corresponds to an unreliable interpolation result. A logical 1 input at multiplexer 180 selects as output signal 28 the vert_int signal 122. If the absolute value of the difference between X_after_median signal 124 and vert_int signal 122 is not greater than the product of vert_int signal 122 and factor 170, the interpolation is deemed to be reliable. Multiplexer 180 will then receive a logical 0 input from comparator 160 and will select as output signal 28 the output signal from five-points median filter 100 (X_after_median signal 124). Output signal 28 is provided from post-processing block 26 to the image display device to be displayed as a part of the interpolated image.

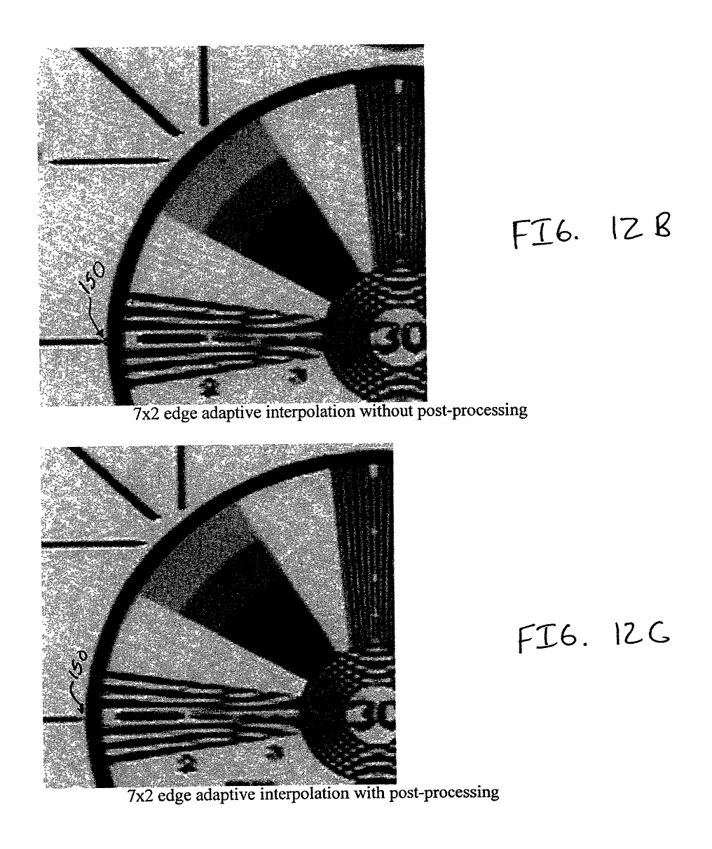

FIG. 12A is a partial screen shot of an image showing the result of an interlace-to-progressive conversion using only vertical interpolation. Jagged edges 200 are clearly visible in FIG. 12A. FIG. 12B is a partial screen shot of the same image after interlace-to-progressive conversion using an embodiment of the edge adaptive interpolation and edge detection algorithms, but without post-processing. Note that the resolution of the image is significantly improved. However, the resulting dot noise is visible as indicated by arrow 150. Lastly, FIG. 12C shows a partial screen shot of the same image after interlace-to-progressive conversion using an embodiment of the proposed method including post-processing as described herein. As can be seen, the dot noise of FIG. 12B has been eliminated, as indicated by arrow 150 of FIG. 12C, which points to the same area as in FIG. 12B.

The sensitivity and reliability of the post-processing can be controlled by varying the product of vert_int signal 122 and factor 170 (i.e., by changing the value of factor 170). Post-processing block 26 can thus provide as an output either the edge adaptive interpolated value for interpolated pixel 12, or a vertical interpolation value, which is the average of the pixels immediately above and immediately below interpolated pixel 12. Factor 170 serves to adjust the sensitivity of the edge interpolation such that the more reliable of the two values is output from post-processing block 26.

Embodiments can be implemented in a computer readable medium as part of a system, such as a computer or a television set. Alternatively, the system can be much smaller, such an integrated circuit. A processor within the system can access the computer readable media and execute the code therein as a set of instructions for the system. The computer readable medium can comprise a hard drive, CD ROM, integrated circuit RAM or ROM, or the like. Thus, the embodiments can be implemented on a CPU in a MIPs processor or in a custom-made chip with etched-in logic. Typically, embodiments can be hard-wired to reduce the computational resources necessary to perform the interpolation. The embodiments can be implemented on an interlace-to-progressive conversion chip, such as that disclosed in the Single-Chip Integration application. The embodiments can thus provide an advantage of reduced defects in an image signal to a display. Unlike the prior art, the post-processing can remove artifacts that are normally encountered with edge adaptive interpolation of an image. The result is a better performing edge adaptive interpolation process and interlace-to-progressive conversion.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

What is claimed is:

1. A method of improving the resolution of a pixilated image, the method comprising:
receiving data for a first group of pixels and a second group of pixels;
determining whether an edge within the image passes though a first pixel located between the first and second groups of pixels;
determining whether the edge extends in a first set of directions or a second set of directions to identify a selected set of directions;
determining that a specific direction within the selected set of directions is closer to an actual direction; and
determining a first value of a parameter for the first pixel in response to determining the specific direction.

2. The method of claim 1, wherein each of the first and second groups of pixels includes at least five pixels.

3. The method of claim 1, wherein each of the first and second groups of pixels includes seven pixels.

4. The method of claim 1, wherein:
the first group of pixels extend in a first direction; and
the second group of pixels extends in a second direction that is substantially parallel to the first direction.

5. The method of claim 1, wherein each of the first and second groups of pixels comprise a same number of pixels.

6. The method of claim 5, wherein a number of directions within each of the first and second sets of directions is an integer equal or closest to:
(Nₚ₁−1)/2
wherein Nₚ₁ is a number of pixels within the first group pixels.

7. The method of claim 1, wherein:
the first set of directions lie between 0 and 90 degrees; and
the second set of directions lie between 90 and 180 degrees.

8. The method of claim 7, wherein determining whether the edge extends in a first set of directions or a second set of directions comprises determining whether the edge extends in a first set of directions, a second set of directions, and a third direction that lies at approximately 90 degrees.

9. The method of claim 8, wherein the acts of:
determining whether an edge within the image passes though a first pixel located between the first and second groups of pixels; and
determining whether the edge extends in a first set of directions or a second set of directions to identify a selected set of directions comprise:
for each pair of pixels within the first and second groups of pixels that correspond to a direction, determining a difference in values of the parameter between the pair of pixels;
summing the differences for each of the first and second sets of directions to form a first summed difference and a second summed difference;
determine a difference in values of the parameter between the pair of pixels corresponding to the third direction to form a third direction difference;
determining absolute values for of the first summed difference, the second summed difference, and the third direction difference;
determining a median for the first summed difference, the second summed difference, and the third direction difference to identify a median value; and
determining an absolute value of a difference between the first summed difference and the second summed difference to form an differential summed difference; and
if the third direction difference is not the median value and the first summed difference is less than the second summed difference, identifying the first set of directions as the selected set of directions; and
if the third direction difference is not the median value and the second summed difference is less than the first summed difference, identifying the second set of directions as the selected set of directions.

10. The method of claim 1, wherein determining that that specific direction within the selected set of directions is closer to the actual direction comprises:
for each pair of pixels that correspond to a direction within the selected set of directions, determining a difference in values of the parameter between the pair of pixels;
determining absolute values for of the differences in values;
determining which of the absolute values has a lower value; and
identifying the direction corresponding to the lower value as the specific direction.

11. The method of claim 1, wherein the parameter is intensity.

12. The method of claim 1, wherein determining the first value of the parameter for the first pixel comprises:
identifying which specific pixels from the first and second groups of pixels correspond to the specific direction;
determining the average of the values of the parameter for the specific pixels; and
setting the first value equal to the average.

13. The method of claim 1, further comprising determining a second value of the parameter for the first pixel after determining the first value.

14. The method of claim 13, wherein determining the second value comprises:
determining values of the parameter for the following pixels:
a second pixel, which within the first group of pixels, is a closest pixel to the first pixel;
a third pixel, which within the second group of pixels, is a closest pixel to the first pixel;
a fourth pixel that lies between the first and second groups of pixels and immediately adjacent to the first pixel; and
a fifth pixel that lies between the first and second groups of pixels and immediately adjacent to the first pixel on a side opposite the fourth pixel;
determining a median value of the parameter for the first, second, third, fourth, and fifth pixels;
determining an average value of the parameter for the second and third pixels; and
determining which of the median value and the average value is used for the second value.

15. A computer readable medium having code embodied therein, the code comprising:
an instruction for receiving data for a first group of pixels and a second group of pixels;
an instruction for determining whether an edge within the image passes though a first pixel located between the first and second groups of pixels;
an instruction for determining whether the edge extends in a first set of directions or a second set of directions to identify a selected set of directions;
an instruction for determining that a specific direction within the selected set of directions is closer to an actual direction; and
an instruction for determining a first value of a parameter for the first pixel in response to determining the specific direction.

16. The computer readable medium of claim 15, wherein each of the first and second groups of pixels includes at least five pixels.

17. The computer readable medium of claim 15, wherein each of the first and second groups of pixels includes seven pixels.

18. The computer readable medium of claim 15, wherein:
the first group of pixels extend in a first direction; and
the second group of pixels extends in a second direction that is substantially parallel to the first direction.

19. The computer readable medium of claim 15, wherein each of the first and second groups of pixels comprise a same number of pixels.

20. The computer readable medium of claim 19, wherein a number of directions within each of the first and second sets of directions is an integer equal or closer to:
(Nₚ₁−1)/2
wherein Nₚ₁ is a number of pixels within the first group pixels.

21. The computer readable medium of claim 15, wherein:
the first set of directions lie between 0 and 90 degrees; and
the second set of directions lie between 90 and 180 degrees.

22. The computer readable medium of claim 21, wherein the instruction for determining whether the edge extends in a first set of directions or a second set of directions comprises an instruction for determining whether the edge extends in a first set of directions, a second set of directions, and a third direction that lies at approximately 90 degrees.

23. The computer readable medium of claim 22, wherein the acts of:
the instruction for determining whether an edge within the image passes though a first pixel located between the first and second groups of pixels; and
the instruction for determining whether the edge extends in a first set of directions or a second set of directions to identify a selected set of directions comprise:
for each pair of pixels within the first and second groups of pixels that correspond to a direction, an instruction for determining a difference in values of the parameter between the pair of pixels;
an instruction for summing the differences for each of the first and second sets of directions to form a first summed difference and a second summed difference;
an instruction for determining a difference in values of the parameter between the pair of pixels corresponding to the third direction to form a third direction difference;
an instruction for determining absolute values for of the first summed difference, the second summed difference, and the third direction difference;
an instruction for determining a median for the first summed difference, the second summed difference, and the third direction difference to identify a median value; and
an instruction for determining an absolute value of a difference between the first summed difference and the second summed difference to form an differential summed difference; and
if the third direction difference is not the median value and the first summed difference is less than the second summed difference, an instruction for identifying the first set of directions as the selected set of directions; and
if the third direction difference is not the median value and the second summed difference is less than the first summed difference, an instruction for identifying the second set of directions as the selected set of directions.

24. The computer readable medium of claim 15, wherein the instruction for determining that the specific direction within the selected set of directions is closer to the actual direction comprises:
for each pair of pixels that correspond to a direction within the selected set of directions, an instruction for determining a difference in values of the parameter between the pair of pixels;
an instruction for determining absolute values for of the differences in values;
an instruction for determining which of the absolute values has a lower value; and
an instruction for identifying the direction corresponding to the lower value as the specific direction.

25. The computer readable medium of claim 15, wherein the parameter is intensity.

26. The computer readable medium of claim 15, wherein the instruction for determining the first value of the parameter for the first pixel comprises:
an instruction for identifying which specific pixels from the first and second groups of pixels correspond to the specific direction;
an instruction for determining the average of the values of the parameter for the specific pixels; and
an instruction for setting the first value equal to the average.

27. The computer readable medium of claim 15, further comprising an instruction for determining a second value of the parameter for the first pixel after determining the first value.

28. The computer readable medium of claim 27, wherein the instruction for determining the second value comprises:
an instruction for determining values of the parameter for the following pixels:
a second pixel, which within the first group of pixels, is a closest pixel to the first pixel;
a third pixel, which within the second group of pixels, is a closest pixel to the first pixel;
a fourth pixel that lies between the first and second groups of pixels and immediately adjacent to the first pixel; and
a fifth pixel that lies between the first and second groups of pixels and immediately adjacent to the first pixel on a side opposite the fourth pixel;
an instruction for determining a median value of the parameter for the first, second, third, fourth, and fifth pixels;
an instruction for determining an average value of the parameter for the second and third pixels; and
an instruction for determining which of the median value and the average value is used for the second value.

29. A system for displaying a pixilated image, wherein the system comprises the computer readable medium of claim 15.
